(19) United States
(12) Patent Application Publication
(10) Pub. No.: US 2002/0188707 A1
(43) Pub. Date: Dec. 12, 2002

(54) Method, computer program and processing system for adapting the polling rate for collecting job information from devices

(76) Inventor: Jody L. Terrill, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/874,790

(22) Filed: Jun. 4, 2001

(51) Int. Cl. G06F 15/173; G06F 15/16

(52) U.S. Cl. 709/223; 709/250

(57) ABSTRACT

A method, computer program and processing system for adapting the polling rate for collecting job information from a device facilitate polling a network-connected device for device and/or job information according to a polling rate which is adapted depending upon job progress information to obtain a desired balance between minimizing network traffic and obtaining a particular level of accuracy in collecting certain information from the device.

### BACKGROUND OF THE INVENTION

1. Field of Invention

The present invention relates generally to network discovery and asset management and, more specifically, to a method, computer program and processing system for adapting the polling rate for collecting job information from a device.

2. Description of the Related Art

A widely adopted printer monitoring and management mechanism is Hewlett-Packard's PJL® (Printer Job Language). The PJL feature set allows the controlling server to monitor the page count on a job basis. Also, PJL provides for identification of print jobs status feedback. The print server can employ this identification to transmit new jobs to the printer as fast as the printer can accept them, and to receive the feedback asynchronously. This capability to allow the overlapping of the job processing is helpful in taking full advantage of the throughput capabilities of printers.

In order to analyze server load and printer utilization, multiple times should be captured for a print job. By way of example, these times (Time and Date) could include: time the job entered the print spooler; time the job was sent to the printer; time the job started printing on the printer (the printer can buffer jobs while still printing a previous job); and time the job completed printing on the printer (includes all pages or a cancellation).

One approach to managing networks is to employ the Simple Network Management Protocol (SNMP), as defined in the Internet RFC 1157. Briefly, SNMP is an application-layer protocol that facilitates the exchange of management information between network devices. SNMP is part of the Transmission Control Protocol/Internet Protocol (TCP/IP) protocol suite and enables network administrators to manage network performance, find and solve network problems, and plan for network growth. The SNMP Management Information Database (MIB) is a collection of hierarchical information comprising managed objects. The managed objects are specific characteristics of a managed device and are comprised of one or more object instances (essentially variables). MIBs are identified by object identifiers.

In order for a SNMP Monitoring Agent (MA) to efficiently collect job related information from, for example, Hewlett-Packard (HP) printers it should read the Job MIB at the correct time. SNMP-based products such as Hewlett-Packard's OpenView®, IBM's NetView/6000®, Sun® Microsystems' SunView® and LANWare's® NTManage® use a combination of polling and asynchronous requests (traps) to monitor the status and performance of a variety of network-based products, including printers. The use of a trap allows the printer to inform the MA of state changes in the print job. However, traps have their problems and drawbacks: SNMP v1 traps are unreliable because they are based on UDP (SNMP v3 traps are reliable, but not widely implemented); on some printers, many traps can be sent over the course of a job (therefore, traps other than those of interest may be received); not all printers support trapping on job status; and printers that do support traps may have a limit to the number of registered trap receivers they offer.

An alternative to traps is to poll the printer for its job information on a regular basis and try and capture the state changes. For example, the MA may be interested in the total pages actually printed and the completion time of the print job. If the MA is to capture the completion time of the print job within 1 (one) second, it must poll at this rate for the duration of the job. For documents that take a long time to print, the MA would have to poll the printer during the entire time to print which can add up to a significant amount of network traffic. This problem is magnified when many MA's are polling many printers for job information.

With the recent trend toward collecting greater amounts of information for the purpose of managing networked devices, tracking resource usage, etc., there is an increasing need to reduce network traffic and processing time when querying devices for job information. To this end, it would be helpful to have a method for adapting the polling rate for collecting job information and completion time from a device such as a printer. It would be particularly helpful to have a tunable method which adjusts delay times for polling in consideration of the particular requirements of a management system, for example, striking an appropriate balance between a permissible amount of network traffic and a needed amount of accuracy in obtaining job completion times. It would also be helpful to have a method for adapting the polling rate for collecting job information which is reliable as well as compatible with employing a SNMP-enabled application to poll the devices.

### SUMMARY OF THE INVENTION

According to the present invention, a method, computer program and processing system for adapting the polling rate for collecting job information from devices serve to minimize or decrease network traffic for a management system which is required to provide a particular level of accuracy in collecting certain job information from the devices. This is accomplished by providing a mechanism for a MA to adapt its polling rate based upon device and/or job information. Although this description is made with reference to printers and print jobs, it should be understood that the principles of the present invention are applicable to other devices and types of jobs. For example, the method of the present invention is also applicable to monitoring multifunction jobs (scan, FAX, copy).

By adjusting the rate at which the MA queries the printer for job information according to an exemplary preferred method of the present invention, the number of exchanges between the MA and the printer is decreased. This results in less processing, by both the MA and the printer, and reduced network traffic.

In a preferred embodiment, a combination of predictive and adaptive polling techniques is employed. By way of example, the MA sets an initial query delay on a predictive basis by determining an expected job completion time (e.g., best-case total print time) from a function performance rating (e.g., rated engine speed) of the polled device. The MA sets the delay times between subsequent queries on an adaptive basis by determining a state of job progress (e.g., actual number of pages printed) from received job information (e.g., MIB object) to adjust the expected job completion time. The polling rate, and thus the delay time until the next query, is adjusted depending upon the recalculated expected job completion time. As a result, the method of the present invention allows the MA to adjust its calculations based upon the actual print speed for a particular job which is particularly useful for larger jobs. This allows the MA to create dynamic PPM information based upon the complexity of the print job and adjust the polling delays accordingly.

In accordance with another embodiment of the present invention, a method for adapting the polling rate for collecting job information from a device includes the steps of: querying a device for job information; determining a state of job progress from the job information; setting a delay time depending upon the state of job progress; and querying the device for job information after the delay time has passed. In a preferred embodiment, an application-layer protocol is employed to poll the device. In a preferred embodiment, a network management protocol request is employed to poll the device. In a preferred embodiment, a Simple Network Management Protocol (SNMP)-enabled application is employed to poll the device. The polled device is, for example, a network-connected device or a printer. In a preferred embodiment, the job information comprises print job information. In a preferred embodiment, the delay time is set to be no less than an acceptable delay time. In a preferred embodiment, the step of setting a delay time includes the steps of: adjusting an expected job completion time depending upon the state of job progress; and determining the delay time from the expected job completion time. In a preferred embodiment, the delay time is set to be less than the expected job completion time. In a preferred embodiment, the delay time is set to be approximately one half of the expected job completion time. In a preferred embodiment, the delay time is set to be within a range of values bounded by a minimum delay time and a maximum delay time.

In accordance with another embodiment of the present invention, a method for adapting the polling rate for collecting job information from a device includes the steps of: querying a device for information; determining an expected job completion time from the information; setting a delay time depending upon the expected job completion time; and querying the device for job information after the delay time has passed. In a preferred embodiment, the information comprises a rated speed of the device such as a rated engine speed or a rated print speed. In a preferred embodiment, the expected job completion time is a best case job completion time.

In accordance with another embodiment of the present invention, a method for adapting the polling rate for collecting job information from a device includes the steps of: (a) querying a device for device and/or job information according to a polling rate; (b) adjusting the polling rate depending upon the device and/or job information; and (c) repeating steps (a) and (b) until a job associated with the device and/or job information is completed. In a preferred embodiment, the device information comprises a function performance rating such as a printing speed rating. In a preferred embodiment, the job information comprises job progress information (such as print job progress information) or print job information.

In accordance with another embodiment of the present invention, a computer program for adapting the polling rate for collecting job information from a device is embodied on a computer usable medium having computer-readable instructions thereon for causing a computer to implement any of the methods disclosed herein.

In accordance with another embodiment of the present invention, a processing system for adapting the polling rate for collecting job information from a device includes a monitoring agent configured to implement any of the methods disclosed herein.

The above described and many other features and attendant advantages of the present invention will become apparent as the invention becomes better understood by reference to the following detailed description when considered in conjunction with the accompanying drawings.

### BRIEF DESCRIPTION OF THE DRAWINGS

Detailed description of preferred embodiments of the invention will be made with reference to the accompanying drawings:

FIG. 1 is a diagram illustrating an exemplary system configuration suitable for implementation of the method for adapting the polling rate for collecting job information from devices of the present invention; and

FIGS. 2A and 2B are a flow diagram illustrating an exemplary preferred method for adapting the polling rate for collecting job information from devices according to the present invention.

### DETAILED DESCRIPTION OF THE PREFERRED EMBODIMENTS

The following is a detailed description of the best presently known mode of carrying out the invention. This description is not to be taken in a limiting sense, but is made merely for the purpose of illustrating the general principles of the invention.

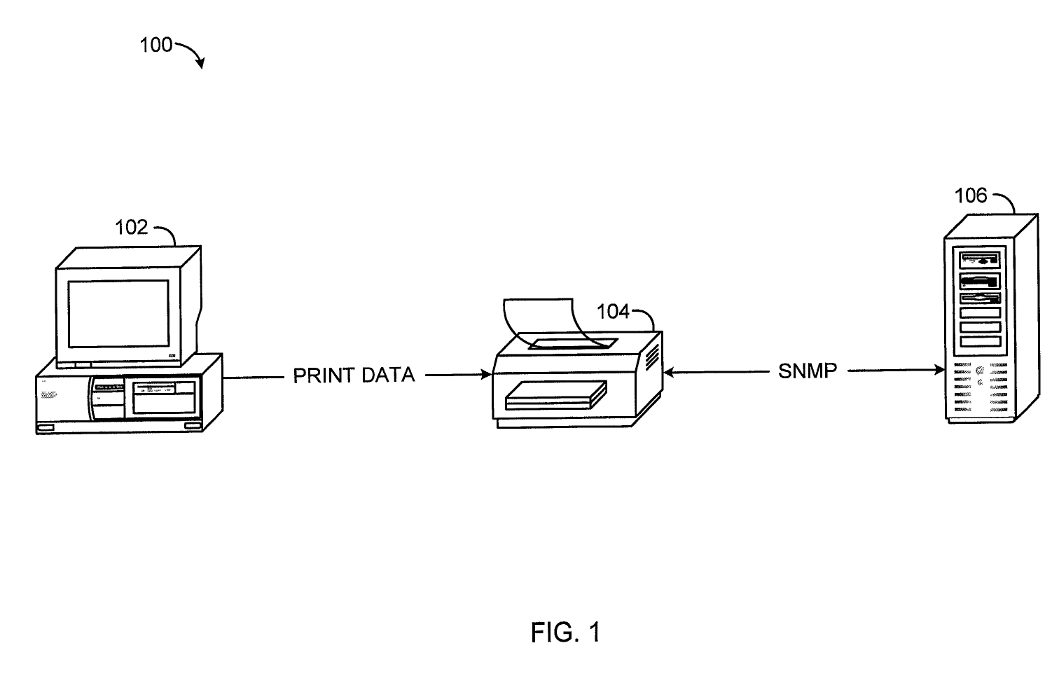

Referring to FIG. 1, an exemplary system 100 suitable for implementation of the method of the present invention is illustrated. The system 100 includes a printing computer 102, a printer 104 and a monitoring agent 106 configured as shown. The printing computer 102 is a print client or spooler and sends the print job (print data) to the printer 104. Only one printing computer 102 is shown in FIG. 1 for the sake of clarity; however, it should be understood that the printing computer 102 can also be a plurality of clients in communication with a server (e.g., NT server) including a print spooler for routing the print data. There may also be a plurality of clients 102 in direct communication with the printer 104.

The printer 104 (e.g., an HP LaserJet printer) is a device that is performing a print function and maintaining print job information. An exemplary preferred printer 104 includes firmware (e.g., an HP JetDirect Card) that provides an interface to the LAN or other network. Although a printer is shown in FIG. 1, it should be understood that other (network-connected) devices can also be queried for information according to the method of the present invention.

The monitoring agent 106 is any device capable of querying the printer 104 for information. An exemplary preferred monitoring agent 106 comprises an SNMP-enabled application such as HP OpenView® and HP Web JetAdmin™. Other protocols and applications can also be employed to facilitate communications between the printer 104 and the monitoring agent 106.

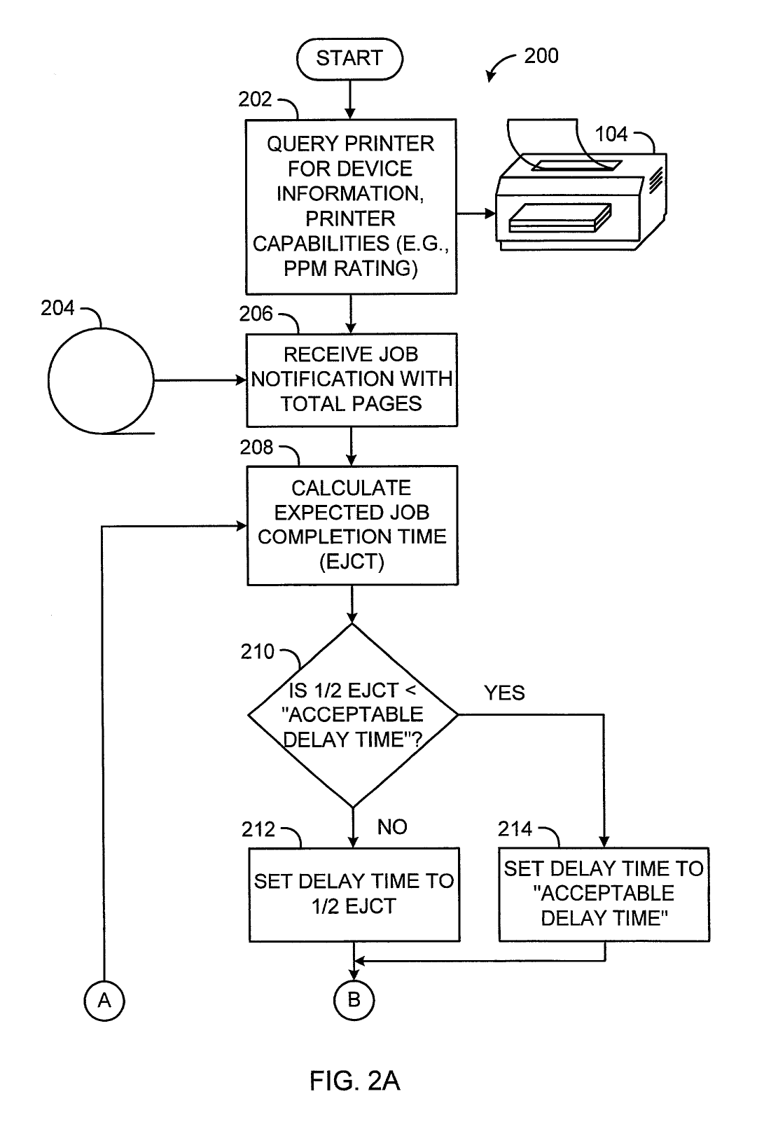

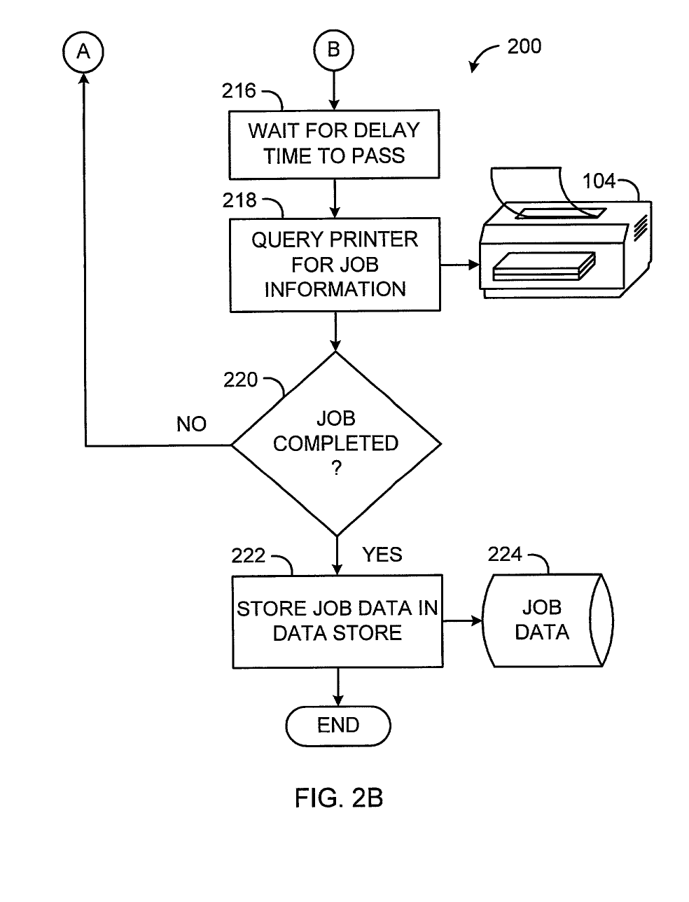

Referring to FIGS. 2A and 2B, an exemplary preferred method 200 for adapting the polling rate for collecting job information from devices is illustrated. In a preferred embodiment, the method 200 serves as an adaptive technique for decreasing the amount of queries that the MA sends to the printer. Minimizing the number of such queries is desirable because they consume network bandwidth, device (e.g., printer) processing time and MA processing time. At step 202, the MA queries the printer 104 (or other device) for device information including device capabilities. This device information includes, for example, the model information, engine speed of the printer, rated print speed (e.g., pages per minute (PPM)) or any other information that allows for a determination of device capability.

At step 206, job information (including, for example, the total number of pages in the print job) is received from the spooler 204. At step 208, an expected job completion time (EJCT) is calculated from the device and/or job information. For example, the EJCT is initially determined from the PPM rating of the printer and the number of pages remaining in the print job. When the MA queries the printer at the start of the print job, it can determine the total pages in the print job and how many have already been printed at that point. The MA can then calculate how long the print job should take to complete based upon the number of pages left to print and the PPM rating of the printer. Based upon this time, a delay until the next query is performed can be determined.

At step 210, if a portion (e.g., half) of the EJCT is less than an “acceptable delay time” (e.g., 1 second), a delay time until the next query is set to the acceptable delay time at step 214. Otherwise, the delay time is set to the portion (e.g., half) of the EJCT at step 212. After waiting for the delay time to pass (step 216), the printer is queried at step 218 for job information (current job status information). At step 220, if the job is completed, job data is stored (step 222) in a data store 224. If the job is not completed, the EJCT is recalculated at step 208 based upon the new information.

At each query a new delay time is calculated based upon the current progress of the job. The MA can utilize a variety of techniques for determining the EJCT. For example, the initial EJCT calculation is based upon the rated engine speed which provides an optimal (or best case) estimate of the completion time. Subsequent calculations of the EJCT determine the actual PPM for the print job based upon the time taken and the number of pages printed and adjust the EJCT accordingly.

The delay between queries can be based upon a number of factors such as the nature of print job, capabilities of the printer, printer life cycle, network traffic, etc. In a preferred embodiment, a balance is reached between delaying the queries until the estimated end of the job and checking the print job for abnormal circumstances such as cancellations. In an exemplary preferred embodiment, a binary technique is employed to set the delay time at one half of the EJCT, but no less than the “acceptable delay time”. In a preferred embodiment, the acceptable delay time (e.g., 1, 2, . . . 10 seconds, etc.) is adjusted or “tuned” to strike a desired balance between minimizing network traffic and monitoring the device for abnormal circumstances (status, alerts, etc.). In a preferred embodiment, the acceptable delay time is selected to allow the MA to capture desired or necessary information within an acceptable time window. An example of how MA queries are made according to the present invention is set forth below.

For a 60-page print job to be printed on a 30 PPM printer:

1. At the beginning of the job, the MA queries the printer for the current job information.

2. Based upon the PPM (30) of the printer and the pages left to print (60), an estimated completion time of 120 seconds is calculated.

3. The MA sets its next query to occur at half this time (60 seconds).

4. At 60 seconds, the MA queries the printer for the current job information.

5. Based upon the new information (30 pages left and a true PPM of 30), an estimated completion time of 60 seconds is calculated.

6. The MA sets its next query to occur at half of this time (30 seconds).

7. The MA continues this process until a minimum acceptable delay is reached (e.g., 1 second) and/or the job is complete.

Using the above example, the following table summarizes the MA queries:

| Time from Start (seconds) | Pages to Print | Printers Pages per Minute |
|---|---|---|
| 0 | 60 | 30 |
| 60 | 30 | 30 |
| 90 | 15 | 30 |
| 105 | 8 | 30 |
| 112 | 4 | 30 |
| 116 | 2 | 30 |
| 118 | 1 | 30 |
| 119 | 1 | 30 |
| 120 | 1 | 30 |

In this example, the MA had to query the printer 9 times in order to capture the necessary information within a ±1 second window. In contrast with the present invention, a MA employing a traditional fixed polling technique in this example would have to query the printer 120 times (once every second) in order to capture the necessary information within a ±1 second window.

The adaptive polling technique of the present invention provides a tunable and efficient mechanism for collecting job times from devices such as printers. By using predictive and adaptive algorithms, the management server can target its polling of the printer to times when print jobs are ending to better capture the start and stop times of print jobs at the printer thereby significantly reducing network traffic.

In addition to collecting the job times from devices such as printers, retrieving the job information from the device in a timely fashion is also important. For example, in most LaserJet printers, there is a limited number of print job information sets that can be maintained. In some cases, the LaserJet printer can maintain information for sixteen jobs at one time. Consequently, the management server must retrieve information for the first job before the seventeenth job is printed or the first job will be lost.

The adaptive polling technique of the present invention also provides a mechanism for collecting the job information and completion time from devices such as printers. By adjusting the delays, the management system can strike a desired balance between minimizing network traffic and maintaining a particular level of accuracy in the collected job completion times.

According to the present invention, the acceptable delay time can also be a range of values bounded by a minimum delay time and a maximum delay time. By way of example, for a 30-page print job to be printed on a 10 PPM printer (job should take 180 seconds to print) with a 2-second minimum delay time, a 30-second maximum delay time and a halting algorithm:

Time 0: The MA predicts the job to take 180 seconds to complete. Half of this is 90 seconds, but the maximum delay time is 30 seconds, so the MA first polls at 30 seconds.

Time 30: The MA then queries the status and predicts the job will now take 150 seconds to complete. Half of this is 75 seconds, but the maximum delay time is 30 seconds, so the MA next polls at 30 seconds.

Time 60: The MA then queries the status and predicts the job will now take 120 seconds to complete. Half of this is 60 seconds, but the maximum delay time is 30 seconds, so the MA next polls at 30 seconds.

Time 90: The MA then queries the status and predicts the job will now take 90 seconds to complete. Half of this is 45 seconds, but the maximum delay time is 30 seconds, so the MA next polls at 30 seconds.

Time 120: The MA then queries the status and predicts the job will now take 60 seconds to complete. Half of this is 30 seconds, and the maximum delay time is 30 seconds, so the MA next polls at 30 seconds.

Time 150: The MA then queries the status and predicts the job will now take 30 seconds to complete. Half of this is 15 seconds which is between the minimum and maximum delay times, so the MA next polls at 15 seconds.

Time 165: The MA then queries the status and predicts the job will now take 15 seconds to complete. Half of this is 7 seconds which is between the minimum and maximum delay times, so the MA next polls at 7 seconds.

Time 172: The MA then queries the status and predicts the job will now take 8 seconds to complete. Half of this is 4 seconds which is between the minimum and maximum delay times, so the MA next polls at 4 seconds.

Time 176: The MA then queries the status and predicts the job will now take 4 seconds to complete. Half of this is 2 seconds which is between the minimum and maximum delay times, so the MA next polls at 2 seconds.

Time 178: The MA then queries the status and predicts the job will now take 2 seconds to complete. Half of this is 1 second, but the minimum delay time is 2 seconds, so the MA next polls at 2 seconds.

Time 180: The MA then queries the status and the job is noted as complete.

In the above example, it took 10 polls to obtain the job completion time within ±2 seconds. Employing a non-adaptive, traditional fixed polling technique (polling every 2 seconds) would have required 36 polls to ensure the same accuracy.

The polling technique of the present invention can be adapted in a variety of different ways, for example, by adjusting the minimum, maximum and adjusting (e.g., half the EJCT) algorithms described above. Moreover, the polling technique can be adapted based upon experience with previous print jobs. For example, the algorithms can be adjusted to take into account a percentage of jobs that are being cancelled, e.g., by closing the window (min/max) and/or adjusting by thirds or some other portion of the EJCT.

The trade-offs involve the amount of network traffic the MA is willing to bear in order to obtain times for successful and aborted jobs that meet (its) requirements for data analysis. Given that most jobs are completed successfully and the analysis of the data of completed job times is typically more important than aborted jobs, tuning the algorithm(s) to capture the completion time of successful jobs while allowing for a wider margin on aborted jobs is generally preferable and limits the amount of network traffic associated with collecting this information.

Devices can be polled for a variety of different types of information such as descriptions, status and alerts concerning the devices and their various subparts. When the MA comprises a SNMP-enabled application, the information received from the devices can be provided via MIB managed objects. By way of example, the following object from the standard Printer MIB (RFC 1759) can be used to determine the maximum speed of the printer; alternatively, other MIB objects can be used to retrieve the make and model of the printer which, in turn, can be used to determine the speed of the printer from known specifications.

Name: prtMediaPathMaxSpeed

Type: OBJECT-TYPE

OID: 1.3.6.1.2.1.43.13.4.1.4

Full path: iso(1).org(3).dod(6).internet(1).mgmt(2).mib-2(1).printmib(43).prtMediaPath(13).prtMediaPathTable(4).prtMediaPathEntry

(1).prtMediaPathMaxSpeed(4)

Module: Printer-MIB

Parent: prtMediaPathEntry

Prev sibling: prtMediaPathMediaSizeUnit

Next sibling: prtMediaPathMaxMediaFeedDir

Numerical syntax: Integer (32 bit)

Base syntax: Integer32

Composed syntax: Integer32

Status: current

Max access: read-only

Description: The maximum printing speed of this media path expressed in prtMediaPathMaxSpeedUnit's. A value of (−1) implies ‘other’.

The following MIB object (job-info-pages-printed) is unique to HP LaserJet printers and is accessible via JetDirect Cards. By monitoring this MIB object, the MA can determine how much of the print job has been printed. It should be understood, however, that other MIB objects (such as those of other printer manufacturers) can be used to determine job progress information.

Name: job-info-pages-printed

Type: OBJECT-TYPE

OID: 1.3.6.1.4.1.11.2.3.9.4.2.1.1.6.5.13

Full path:

iso(1).org(3).dod(6).internet(1).private(4).enterprises(1).hp(11).nm(2).system(3).net-

peripheral(9).netPML(4).netPMLmgmt(2).device(1) .system(1).job(6).job-info(5).job-info-pages-printed(13)

Module: HP-Color-LaserJet-4500-MIB

Parent: job-info

Prev sibling: job-info-pages-processed

Next sibling: job-info-size

Numerical syntax: Integer (32 bit)

Base syntax: INTEGER

Composed syntax: INTEGER

Status: optional

Max access: read-only

Description: Indicates the number of pages printed by the destination subsystem. If none of the eSourceSubsystem, cProcessingSubsystem or cDestinationSubsystem items are in the associated OB-INFO-STAGE object, then this object contains the total number of pages printed for this job. This value may increase by two each time for duplex jobs. The last OID field for this dynamic object contains the job ID. Additional information: If multiple copies of a page are printed, each copy is counted individually. In LaserJet 4500, the value does increase by two for duplex jobs. There will be between 0 and 16 instances of this object in the printer at any given time since the printer keeps track of up to 16 jobs.

Other MIBs, for example, the Job Monitoring MIB (RFC 2707), can also be used to provide objects and attributes for monitoring the progress of a job.

Although the present invention has been described in terms of the preferred embodiment above, numerous modifications and/or additions to the above-described preferred embodiment would be readily apparent to one skilled in the art. It is intended that the scope of the present invention extends to all such modifications and/or additions.

I claim:

1. A method for adapting the polling rate for collecting job information from a device, the method comprising the steps of:
querying a device for job information;
determining a state of job progress from the job information;
setting a delay time depending upon the state of job progress; and
querying the device for job information after the delay time has passed.

2. The method for adapting the polling rate for collecting job information from a device of claim 1, wherein an application-layer protocol is employed to poll the device.

3. The method for adapting the polling rate for collecting job information from a device of claim 1, wherein a network management protocol request is employed to poll the device.

4. The method for adapting the polling rate for collecting job information from a device of claim 1, wherein a Simple Network Management Protocol (SNMP)-enabled application is employed to poll the device.

5. The method for adapting the polling rate for collecting job information from a device of claim 1, wherein the device is a network-connected device.

6. The method for adapting the polling rate for collecting job information from a device of claim 1, wherein the device is a printer.

7. The method for adapting the polling rate for collecting job information from a device of claim 1, wherein the job information comprises print job information.

8. The method for adapting the polling rate for collecting job information from a device of claim 1, wherein the delay time is set to be no less than an acceptable delay time.

9. The method for adapting the polling rate for collecting job information from a device of claim 1, wherein the step of setting a delay time includes the steps of:
adjusting an expected job completion time depending upon the state of job progress; and
determining the delay time from the expected job completion time.

10. The method for adapting the polling rate for collecting job information from a device of claim 9, wherein the delay time is set to be less than the expected job completion time.

11. The method for adapting the polling rate for collecting job information from a device of claim 9, wherein the delay time is set to be approximately one half of the expected job completion time.

12. The method for adapting the polling rate for collecting job information from a device of claim 9, wherein the delay time is set to be within a range of values bounded by a minimum delay time and a maximum delay time.

13. A method for adapting the polling rate for collecting job information from a device, the method comprising the steps of:
querying a device for information;
determining an expected job completion time from the information;
setting a delay time depending upon the expected job completion time; and
querying the device for job information after the delay time has passed.

14. The method for adapting the polling rate for collecting job information from a device of claim 13, wherein the information comprises a rated speed of the device.

15. The method for adapting the polling rate for collecting job information from a device of claim 14, wherein the rated speed is a rated engine speed.

16. The method for adapting the polling rate for collecting job information from a device of claim 14, wherein the rated speed is a rated print speed.

17. The method for adapting the polling rate for collecting job information from a device of claim 13, wherein the expected job completion time is a best case job completion time.

18. A method for adapting the polling rate for collecting job information from a device, the method comprising the steps of:
(a) querying a device for device and/or job information according to a polling rate;
(b) adjusting the polling rate depending upon the device and/or job information; and
(c) repeating steps (a) and (b) until a job associated with the device and/or job information is completed.

19. The method for adapting the polling rate for collecting job information from a device of claim 18, wherein the polling rate is adjusted such that a delay time until a next query to the device is no less than an acceptable delay time.

20. The method for adapting the polling rate for collecting job information from a device of claim 18, wherein the polling rate is adjusted such that a delay time until a next query to the device is set to be within a range of values bounded by a minimum delay time and a maximum delay time.

21. The method for adapting the polling rate for collecting job information from a device of claim 18, wherein the device information comprises a function performance rating.

22. The method for adapting the polling rate for collecting job information from a device of claim 21, wherein the function performance rating is a printing speed rating.

23. The method for adapting the polling rate for collecting job information from a device of claim 18, wherein the job information comprises job progress information.

24. The method for adapting the polling rate for collecting job information from a device of claim 23, wherein the job progress information comprises print job progress information.

25. The method for adapting the polling rate for collecting job information from a device of claim 18, wherein the job information comprises print job information.

26. A computer program for adapting the polling rate for collecting job information from a device comprising:
a computer usable medium having computer-readable instructions thereon for causing a computer to query a device for job information, determine a state of job progress from the job information, set a delay time depending upon the state of job progress, and query the device for job information after the delay time has passed.

27. A processing system for adapting the polling rate for collecting job information from a device comprising:
a monitoring agent configured to query a device for job information, determine a state of job progress from the job information, set a delay time depending upon the state of job progress, and query the device for job information after the delay time has passed.
